(19) United States
(12) Patent Application Publication
(10) Pub. No.: US 2014/0088856 A1
(43) Pub. Date: Mar. 27, 2014

(54) LOCATION METADATA BASED ON PEOPLE VISITING THE LOCATIONS

(71) Applicants: Rita H. Wouhaybi, Portland, OR (US); Stanley Mo, Hillsboro, OR (US); Tobias Kohlenberg, Portland, OR (US); Steven Birkel, Portland, OR (US); Annabel Nickles, Portland, OR (US)

(72) Inventors: Rita H. Wouhaybi, Portland, OR (US); Stanley Mo, Hillsboro, OR (US); Tobias Kohlenberg, Portland, OR (US); Steven Birkel, Portland, OR (US); Annabel Nickles, Portland, OR (US)

(21) Appl. No.: 13/629,536

(22) Filed: Sep. 27, 2012

(51) Int. Cl. G06F 17/30; G08G 1/00

(52) U.S. Cl. 701/118; 707/736; 707/E17.005

(57) ABSTRACT

Methods and systems for a location metadata system are disclosed. A data storage subsystem stores collected data associated with locations and users. A network interface is coupled to the data storage subsystem. The network interface manages communication with devices of users to collect data associated with the locations and users. A data analysis system includes a processor adapted for obtaining the collected data from the data storage subsystem and for analyzing the collected data to create a first location identity associated with interaction of users with a first location.

### BACKGROUND

When visiting a neighborhood or a city, visitors will often remember that one or more friends have visited in the past and the visitors wished they could ask the one or more friends about favorite restaurants, sites, bars, etc. Similarly, when dining in a restaurant, the diner may recollect a friend talking about a restaurant reminiscent of the current restaurant and may wonder whether this is the restaurant that the friend was talking about all the time. Another instance may occur when someone is walking down a street in a neighborhood and wonders what kind of people eat, visit, live or work there. Further, a property owner may need to understand and evaluate the potential of their property and what kind of business they can start at a specific location. However, such information is difficult to obtain and cannot be obtained instantly.

In today's world, a number of social networking applications, e.g., Sonar, Twitter®, Facebook®, and Foursquare®, are enabling users to track location, and using this information, to capture, hold, and propagate contextual information. However, the association of the contextual information with the location is always one way in terms of association. More specifically, locations visited are attached to the person and not vice versa. As a result, the usages are centered around offering recommendations of places to visit to a user based on previous places they have visited.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a Yelp site for Scoop Handmade Ice Cream;

FIG. 2 shows a system diagram of a location metadata system based on visits by people to the locations according to an embodiment;

FIGS. 3a-b illustrate cloud tags for profiles or identities of users created by the location metadata system (LMS) according to an embodiment;

FIG. 4 illustrates a use of a location metadata system based on visits by people to the locations according to another embodiment;

FIG. 5 illustrates a location metadata system based on visits by people to the locations according to another embodiment;

FIG. 6 illustrates a location metadata system based on visits by people to the locations according to another embodiment;

FIG. 7 illustrates a location metadata system based on visits by people to the locations according to another embodiment;

FIG. 8 illustrates a location metadata system based on visits by people to the locations according to another embodiment;

FIG. 9 illustrates a location metadata system based on visits by people to the locations according to another embodiment;

FIG. 10 illustrates a location metadata system based on visits by people to the locations according to another embodiment;

FIG. 11 illustrates a block diagram of a LMS according to an embodiment;

FIG. 12 is a flowchart of a method for creating location profiles using location metadata obtained from people visiting locations according to an embodiment.

### DETAILED DESCRIPTION

By turning the usage the other way around, i.e., using data to center the contextual information on the location rather than the person, identities are associated with locations rather than persons. As a result, these identities may be exposed to users and applications in order to create different views whether they are global or specific to a user's interests or social network. Historical and archival records regarding people and objects are integral to implementing the embodiments described herein.

Accordingly, a location profile may be created that provides an identity and different views of the identity for a location based on the people who visit and interact with this location. An interaction may be defined by spending time in the location or even driving on the street at a particular location. In fact, the data could be saved regarding a user's interaction with a location irrespective of the length of the visit. Thus, location identity is derived from the correlation of metadata from, and about, individuals that interact with the location. The length of time and frequency of the interaction, though, might affect how much the individual is affecting the location metadata. Data from individuals can either be profile information based on existing social media site content, or context information based on virtual association, e.g., social media site interaction, or physical association, e.g., visiting a location. The accumulation of correlated metadata from many individuals over time strengthens the location profile.

Users usually have an account at one or more social networking services, such as Facebook®, Twitter®, and Foursquare®. Each of these accounts contains information related to users' profiles, preferences and behavior. Some of this information has been explicitly entered by users, such as employer, education, name, gender, marital status, likes and dislikes. Other information has been contributed by people in their social networks such as communication on the common social wall or tweets sent to a person. In addition, these sites have a list of friends and acquaintances in a person's social network.

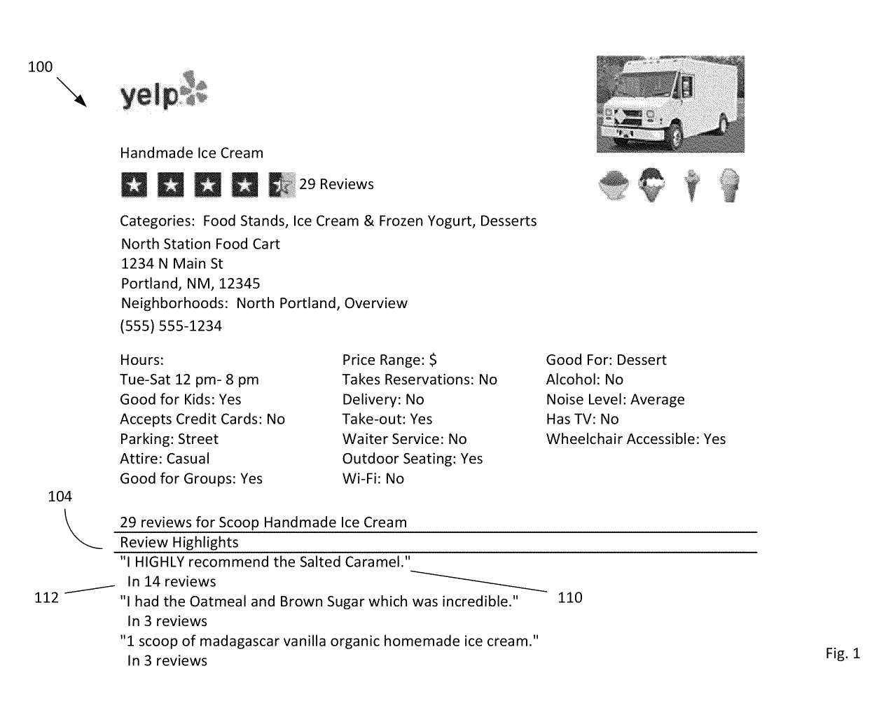

As for locations, in today's world most businesses and landmarks have an online identity. These identities are often instrumental to businesses being located and include information such as the name of the location and its function. An example how a an online identity could be used to provide information specifying that “That Elephant” is a That Restaurant. However, there is no way to know more contextual information about the location. For example, user may be confused because this location is identified as the favorite lunch spot of the local IP industry, but is identified as the preferred dinner location for hipsters and artists. Some sites, such as Yelp, attempt to create an identity for some locations, mainly restaurants, but this identity relies on predefined categories. An example of such identities may include categories such as “good for kids,” “accepts credit cards,” “romantic,” etc. In other cases, sites like Yelp also try to highlight quotes from reviews. FIG. 1 illustrates an example of highlighted quotes on sites.

FIG. 1 shows a Yelp site 100 for Scoop Handmade Ice Cream. The Yelp site 100 includes a review section 104. The review section 104 shows a highlight for “Salted Caramel” 110 in a prominent piece of metadata associated with a location using fourteen reviews 112. These pieces of metadata, the fourteen reviews 112, are obtained through manual entry of reviews by people visiting these locations. If a user wanted to know more about the people visiting these locations, she would need to obtain more information than is included in the reviews alone. In fact, the user would have to click on each review and then click on the user name of the person who wrote the review and read more about them and their numerous reviews of other places in order to come up with any conclusion. Even then, this manual process involving lengthy lookups will not tell the user who else visits this location and when.

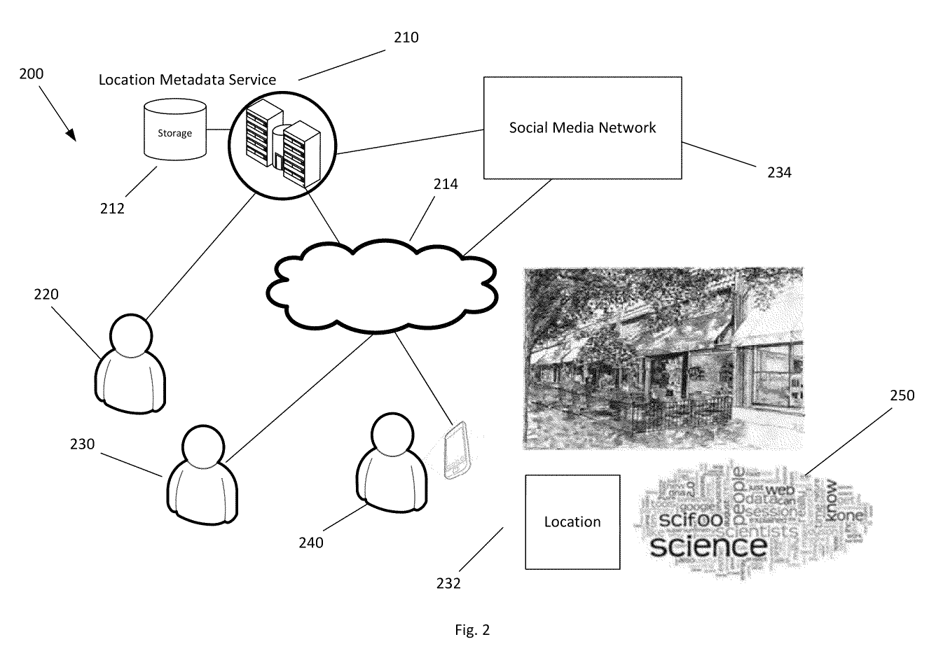

FIG. 2 shows a system diagram 200 of a location metadata system based on visits by people to the locations according to an embodiment. In FIG. 2, the Location Metadata Service (LMS) 210 creates profiles of all participating users 220, 230, 240. A user is considered participating if they either check into or twitter about a location, use any service in the future that allows verification that the user has indeed been to this location, or download and run an application for the service on their mobile device. By accessing information through the Internet 214, the LMS 210 creates profiles and/or identities by harvesting as much information as possible about users 220, 230, 240 by looking at their data on the social networking websites and at other data the users 220, 230, 240 contribute to online sites. The LMS 210 stores the data in a storage system 212.

A first user 220 signs up for the LMS service. However, some users might not sign up to the service or even be aware of it. These users are active members of another service where they publish their visits to the locations. Thus, a second user 230 may check-in to a location 232 using, for example, Foursquare® or another social networking service 234. Other users, e.g., third user 240, are active members of the LMS 210 by having earlier signed-up for the service. When the second user 230 and third user 240 visit the location 232, their visits are logged directly to the LMS 210.

The LMS 210 will then use the information of the first user 220 and the second user 230, based on their identities, to create an identity of people who visit this location 232. The combination of the identities may be normalized or the frequency of their visits could be analyzed. Other factors to include could also include the time of day and day of the week of the visits.

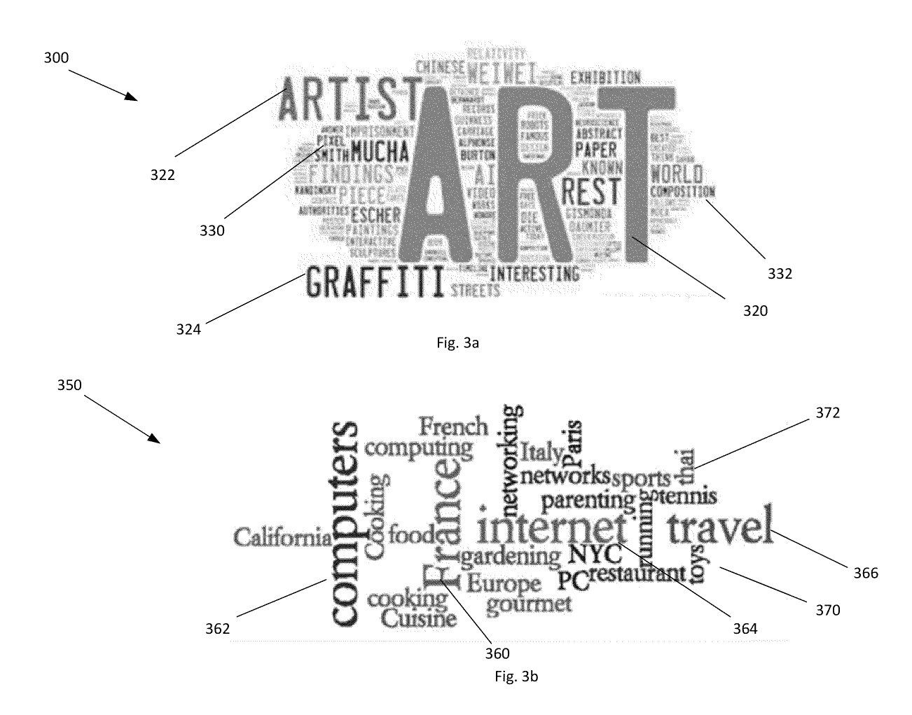

FIGS. 3a-b illustrate cloud tags 300, 350 for profiles or identities of users created by the LMS (such as LMS 210 of FIG. 2) according to an embodiment. The LMS harvests as much information as possible about the users by looking at their data on the social networking websites and other information they contribute to as described above with reference to FIG. 2. FIGS. 3a-b show the minimum and the highest ranking of identity tags associated with an aggregation of the identities for all users who visited location 232 shown in FIG. 2 that are detected either through an application or by harvesting online check-ins. In FIGS. 3a-b, words are used to represent metadata that has been collected, and the words are arranged so that the importance or other characteristics are represented by different font sizes and colors. This format is useful for quickly perceiving the most prominent terms and for locating a term alphabetically to determine its relative prominence. The terms may be hyperlinked to items associated with the tag.

For example, in FIG. 3a, art 320, artist 322 and graffiti 324 have the largest fonts and thus represent terms assigned the highest priority. The terms pixel 330 and composition 332 are assigned a much lower priority. In FIG. 3b, France 360, computers 362, internet 364 and travel 366 have the largest fonts and thus represent terms of highest priority, wherein France 360 is displayed in red to give it a higher visual significance than the others. Toys 370 and that 372 have a much smaller font size and are therefore much lower priority terms. Note that profiles/identities do not need to be stored or represented as a cloud of tags. Other representations, such as the top keywords that represent a person or a location, or even more complex ways such as Federated IDs, may be used.

Referring again to FIG. 2, when the third user 240 requests the identity of the location 232, the third user 240 is presented with a profile/identity 250 of the location 232. The third user 240 may obtain the profile/identity 250 by clicking on a map, or pointing their mobile device towards the location 232. However, the third user 240 may submit questions that are more contextually complex and rich, such as, show the profile/identity 250 of the location 232 with people visiting during weekends. Alternatively, the third user 240 may request for the service to show people visiting over the last week, people who are within 10 years of the user's age, people with children, people who were accompanied by at least one other person, or people in the user's social network. When the third user 240 requests the LMS 210 to identify people in the user's social network, the LMS 210 may protect the identity of these individuals so that the exact names are not disclosed, but only how many, their interests, demographics, etc.

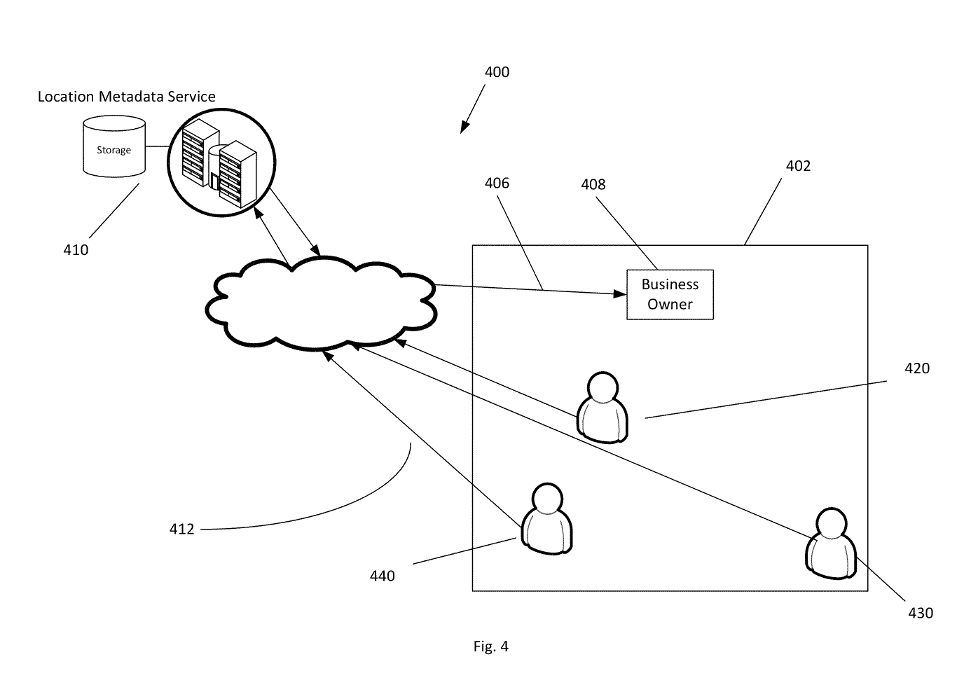

Businesses may also be helped through different use cases. FIG. 4 illustrates a use of a location metadata service system 400 based on visits by people to a location 402 according to another embodiment. In FIG. 4, the location 402 obtains further information 412 regarding visitors 420, 430, 440 so the business owner 408 at the location 402 can understand more about who is visiting and what their interests are. A LMS 410 collects the information 412 from the visitors 420, 430, 440 at the location 402. The LMS 410 then processes the collected information 412 to identify and/or characterize the customers and their interests. The processed data 406 is then provided to the business owner 408 so that the business owner 408 can understand more about who is visiting and what their interests are. The business owner 408 may analyze the processed data 406 to identify ways to better cater to the needs of visitors 420, 430, 440 and provide more services that they might be interested in.

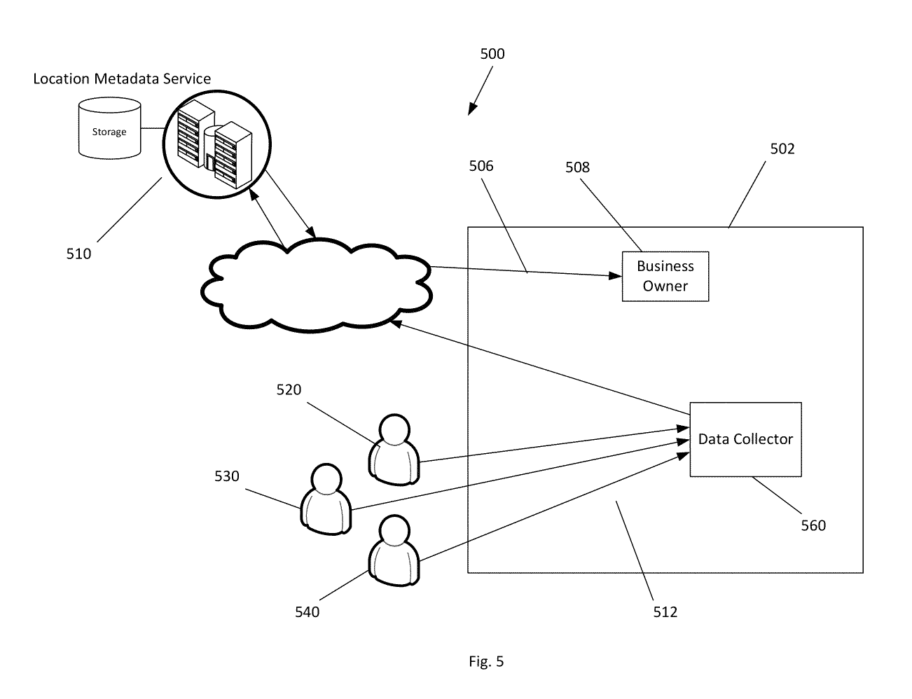

FIG. 5 illustrates a location metadata service system 500 based on visits by people to the location 502 according to another embodiment. In FIG. 5, a data collector 560 at location 502 obtains information 512 from people 520, 530, 540 that stand outside the location 502 to read the menu in the window or check the price tags, but never enter the location 502. This information 512 is provided to LMS 510. The LMS 510 processes the information 512 and provides the processed data 506 to the business owner 508. The business owner 508 may analyze the data 506 and develop a marketing strategy to target the people 520, 530, 540. Thus, business opportunities may be presented to the business owner 508 that might otherwise be lost.

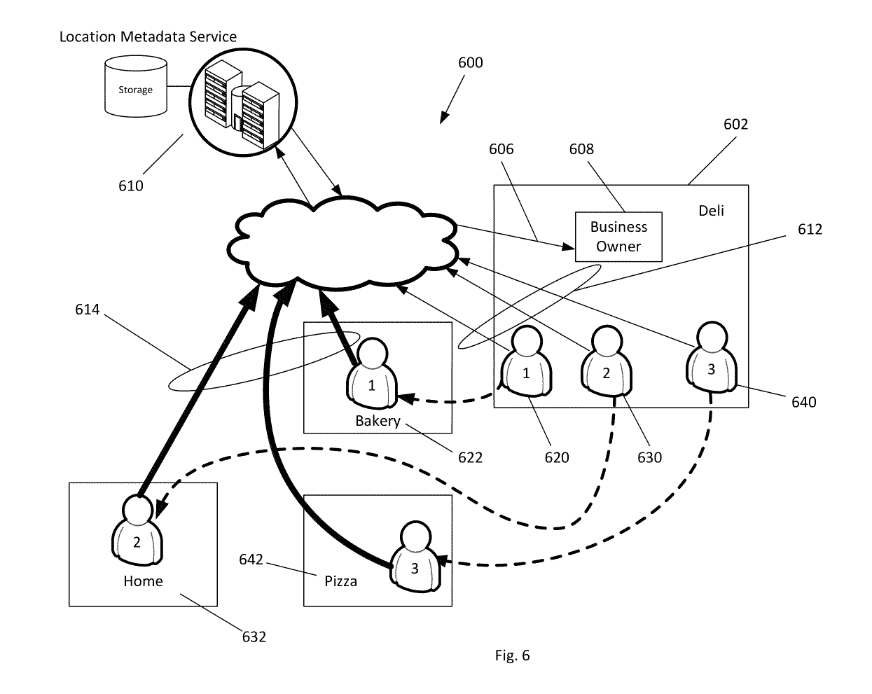

FIG. 6 illustrates a location metadata service system 600 based on visits by people to location 602 according to another embodiment. In FIG. 6, three patrons 620, 630, 640 visit a location 602, such as a deli. Information 612 regarding the patrons 620, 630, 640 at the location 602 are uploaded to LMS 610. Later, the patrons 620, 630, 640 leave the location 602. The first patron 620 goes to a bakery 622. The second patron 630 goes home 632. The third patron 640 goes to a pizza parlor 642. Information 614 identifying the new location of patrons 620, 630, 640 are provided to the LMS 610. The LMS 610 processes the information 612, 614 and provides the processed data 606 to the business owner 608. Thus, if the business owner 608 notices that people order sandwiches to go from the location 602, i.e., the deli, the business owner 608 would benefit from knowing that patron 640 heads to a pizza parlor 642 to buy a pizza. This could tell business owner 608 that if they offer a pizza these patrons might decide to eat on site and may also purchase dessert as a consequence or even drinks, as suggested by patron 620 visiting a bakery after leaving the location 602.

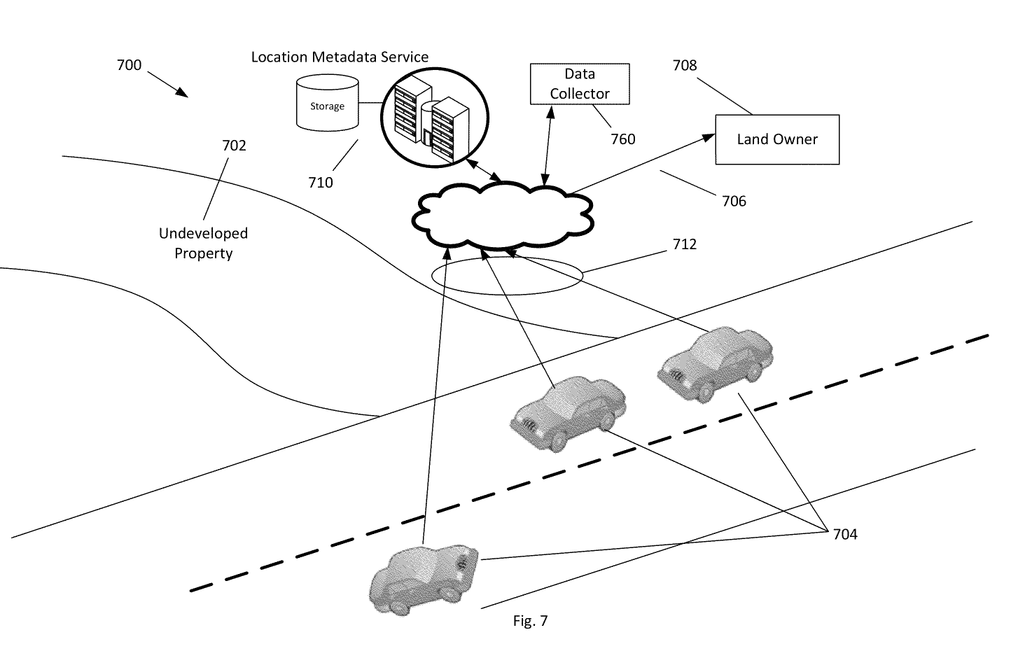

FIG. 7 illustrates a location metadata system based on visits by people to the locations 700 according to another embodiment. In FIG. 7, an owner 708 of undeveloped property 702 obtains data 712 regarding cars 704 that pass by the property 702. Data 712 from cars 704 passing by the property 702 is collected by a data collection service 760 in the crowd. This data 712 is provided to LMS 710 for processing. The LMS 710 provides the processed data 706 to the owner 708. The owner 708 of the property 702 analyzes the received processed data 706 to identify the interests and destinations of the owners of cars 704 driving in front of the property 702. As a result, the land owner 708 may conclude based on the collected data 712 that these people might stop if the development contained a juice store, but will probably not stop if the development contained a pizza restaurant. This could also change over time, and the property owner 708 could subscribe to the LMS 710 to stay updated on potential customers and new opportunities.

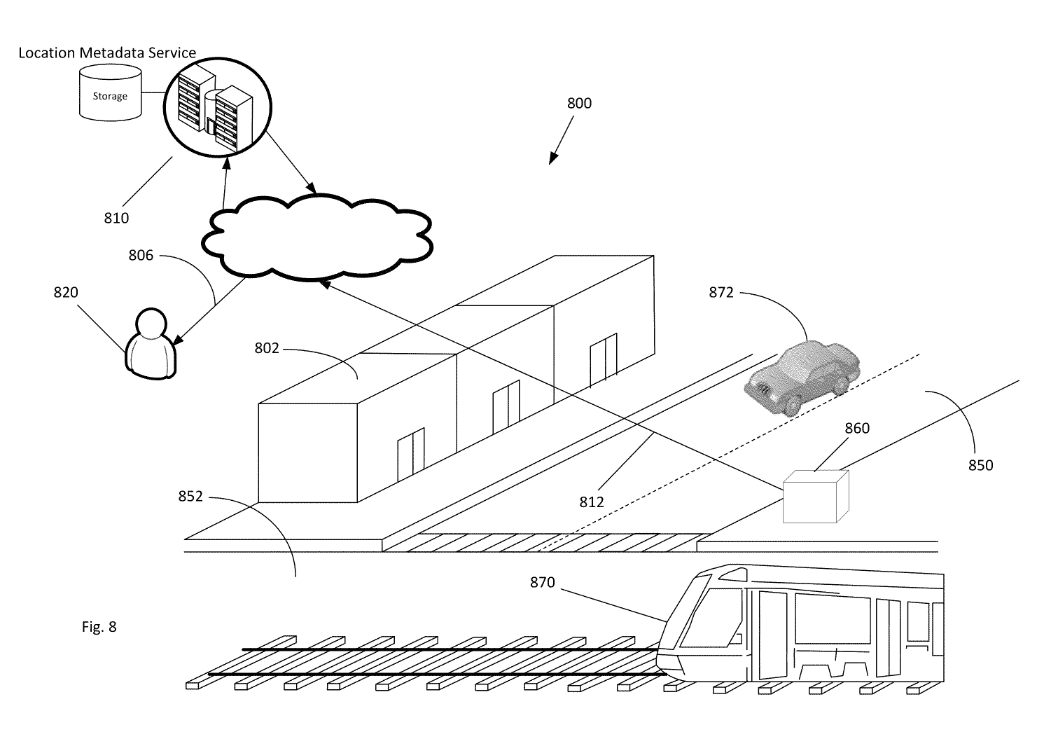

FIG. 8 illustrates a location metadata system based on visits by people to the locations 800 according to another embodiment. According to FIG. 8, information regarding objects proximate a location 802, such as a business location, may be used to influence the identity of locations 800. For example, in FIG. 8, a data collector 860 is disposed near the business location 802. The data collector 860 provides, to LMS 810, traffic volume information 812 regarding roads 850, 852 at different times of day. The traffic volume information 812 is processed to provide trip planning information 806 to a user 820. The user 820 uses the trip planning information 806 from the LMS 810 to plan a trip to the business location 802. The LMS 810 may also correlate the traffic volume information 812 with traffic data and/or local station data associated with light rail 870 for provisioning with the trip planning information 806. The user 820 may thus use the correlated data provided in the trip planning information 806 to determine whether it would be better to take public transportation, such as light rail 870, or drive 872.

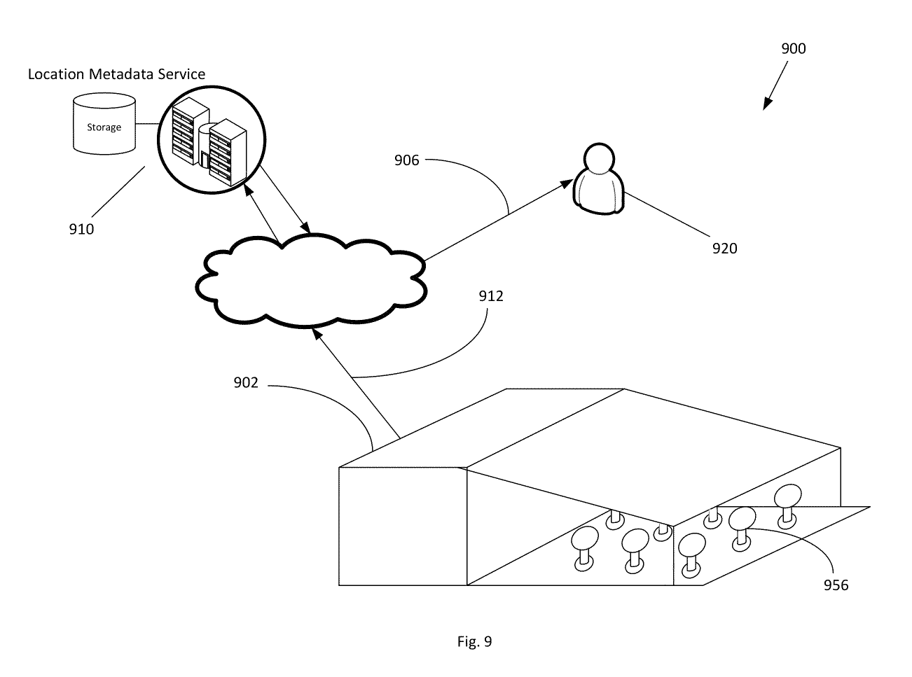

FIG. 9 illustrates a location metadata system based on visits by people to the locations 900 according to another embodiment. In FIG. 9, a user 920 requests information 912 regarding status of an object 956, such as a table at a restaurant, seats at a theater, concert tickets, etc., associated with a location 902, such as a café, movie theater, concert venue, etc. An LMS 910 gathers the information 912. The information 912 may be pushed to the LMS 910, pulled by the LMS 910 according to a trigger, or obtained by the LMS 910 in response to the request from the user 920. After processing the information 912, status information 906 associated with an object 956 at the location 902 is provided to the user 920. Thus, the user 920 may use the information 912 to determine an action with respect to the location 902 based on the received status information 912 associated with the object 956 at the location 902. For example, if the location 902 is a café and the object 956 is seating, the user 920 may receive seating availability information 912 to determine whether the location 902, e.g., café, has outside tables available and whether the café has tables available in the shade or in the sun.

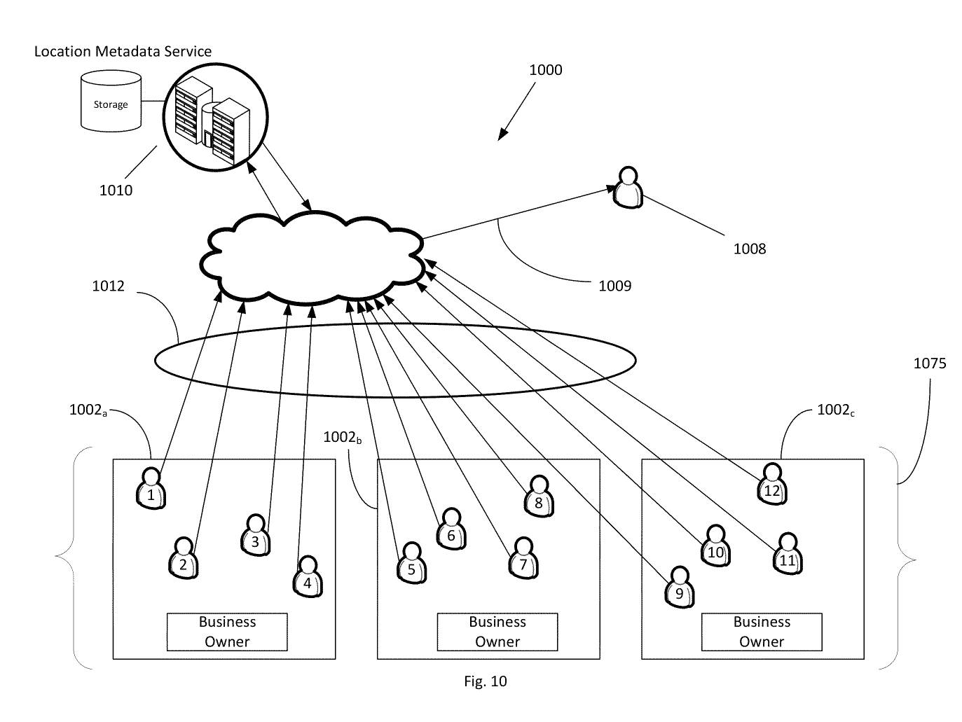

FIG. 10 illustrates a location metadata system based on visits by people to the locations 1000 according to another embodiment. In FIG. 10, information 1012 about users₁₋₁₂ is collected by LMS 1010 from several locations 1002ₐ, 1002_{b}, 1002_{c}. The information 1012 is aggregated to create an identity for each of the locations 1002ₐ, 1002_{b}, 1002_{c}. Then, the identity of each of the locations 1002ₐ, 100_{b}, 1002_{c} is aggregated by the LMS 1010 to provide an identity for a neighborhood 1075. A remote user 1008 may be provided information associated with the identity the locations neighborhood 1075 via link 1009.

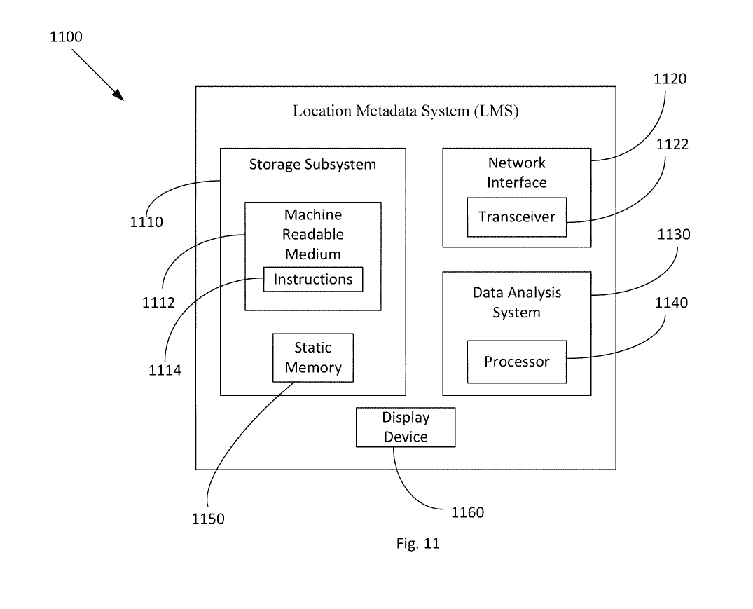

FIG. 11 illustrates a block diagram of a location metadata system (LMS) 1100 according to an embodiment. In FIG. 11, the LMS 1100 includes a data storage subsystem 1110 for storing collected data associated with locations and users, including data regarding locations visited by the user and user profiles. A network interface 1120 manages communication with devices of users to collect data associated with locations and users. The network interface 1120 includes a transceiver 1122 for receiving messages from and transmitting messages to the users. The LMS 1100 also includes a data analysis system 1130. The data analysis system 1130 includes a processor 1140 adapted for analyzing the collected data to create location profiles associated with interaction of users with the locations. An interaction may be defined as spending time at the location or even driving on the street at a particular location. Moreover, the collected user data may be related to the profile, preferences and behavior of a user entered by the user, and to information contributed by people in their social networks.

One or more of the techniques (e.g., methodologies) discussed herein may be performed using the location metadata system (LMS) 1100 of FIG. 11. In alternative embodiments, the location metadata system (LMS) 1100 may operate as a standalone device or may be connected (e.g., networked) to other machines. In a networked deployment, the location metadata system (LMS) 1100 may operate in the capacity of a server machine, a client machine, or both in server-client network environments. In an example, the location metadata system (LMS) 1100 may act as a peer machine in peer-to-peer (P2P) (or other distributed) network environment. The location metadata system (LMS) 1100 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose processor 1140 configured using software, the general-purpose processor 1140 may be configured as respective different modules at different times. Software may accordingly configure processor 1140, for example, to constitute a particular module at one instance of time and to constitute a different module at a different instance of time. As described above, location metadata system (LMS) 1100 (e.g., computer system) may include a processor 1140, which may be a hardware processor (e.g., a central processing unit (CPU), a graphics processing unit (GPU), a hardware processor core, or any combination thereof. The LMS 1100 may further include a display device 1160, such as a touchscreen display.

The data storage subsystem 1110 for storing collected data may include a machine readable medium 1112 on which is stored one or more sets of data structures or instructions 1114 (e.g., software) embodying or utilized by any one or more of the techniques or functions described herein. The instructions 1114 may instead, or also, reside, completely or at least partially, within the data storage subsystem 1110, within static memory 1150, or within the processor 1140 during execution thereof by the LMS 1100. In an example, one or any combination of the processor 1140, data storage subsystem 1110, or the static memory 1150 may constitute machine readable media.

While the machine readable medium 1112 is illustrated as a single medium, the term “machine readable medium” may include a single medium or multiple media (e.g., a centralized or distributed database, and/or associated caches and servers) that configured to store the one or more instructions 1114.

The term “machine readable medium” may include any medium that is capable of storing, encoding, or carrying instructions for execution by the LMS 1100 and that cause LMS 1100 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1114 may further be transmitted or received over a communications network using a transmission medium via the network interface 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks such as Global System for Mobile Communications (GSM), Universal Mobile Telecommunications System (UMTS), CDMA 2000 1x* standards and Long Term Evolution (LTE)). Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, or other protocols now known or later developed.

In an example, the network interface 1120 may include one or more physical jacks (e.g., Ethernet, coaxial, or phone jacks) or one or more antennas to connect to the communications network. In an example, the network interface 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by LMS 1100, and includes digital or analog communications signals or other intangible medium to facilitate communication of such software.

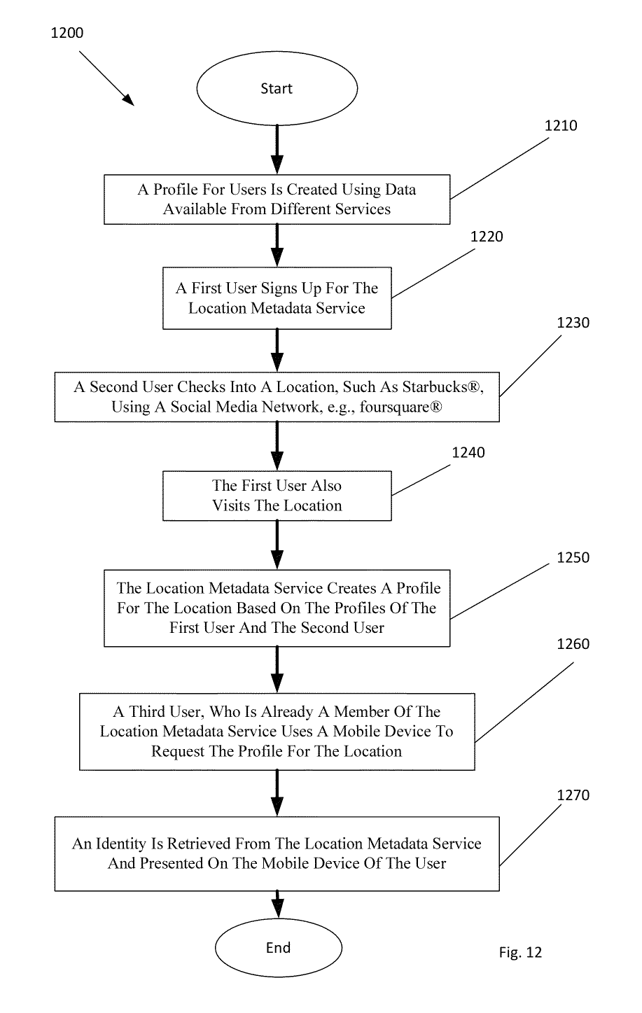

FIG. 12 is a flowchart of a method 1200 for creating location profiles using location metadata obtained from people visiting locations according to an embodiment. In operation 1210, a profile for users is created using data available from different services, such as Sonar, Twitter®, Facebook®), and Foursquare®. A first user signs up for the location metadata service in operation 1220. In operation 1230, a second user checks into a location, such as Starbucks®, using a social media network, e.g., foursquare. In operation 1240, the first user also visits the location. The location metadata service creates a profile for the location based on the profiles of the first user and the second user in operation 1250. A third user who is already a member of the location metadata service uses a mobile device to request the profile for the location in operation 1260. An identity is retrieved from the location metadata service and presented on the mobile device of the user in operation 1270. The method 1200 ends following operation 1270.

### Additional Notes & Examples:

Example 1 includes subject matter (such as a location metadata system, apparatus or network interface device for providing location-based metadata) comprising a data storage subsystem for storing collected data associated with locations and users. The subject matter may also include a network interface, coupled to the data storage subsystem, for managing communication with devices of users to collect data associated with the locations and users. The subject matter may also include a data analysis system including a processor, the processor adapted for obtaining the collected data from the data storage subsystem and analyzing the collected data to create a first location identity associated with interaction of users with a first location.

Example 2 may optionally include the subject matter of Example 1 wherein the collected data include locations visited by the user and profiles associated with the users.

Example 3 may optionally include the subject matter of any one or more of Examples 1 and 2, wherein the network interface includes a transceiver for receiving messages from and transmitting messages to users.

Example 4 may optionally include the subject matter of any one or more of Examples 1-3, wherein the collected data comprises profile information based on existing social media site content, context information about the location, interactions with social media sites and physical association with a location.

Example 5 may optionally include the subject matter of any one or more of Examples 1-4, wherein the data analysis system normalizes the location identities.

Example 6 may optionally include the subject matter of any one or more of Examples 1-5, wherein the location identity includes a collection of metadata and associated weights, the metadata represented by a tag cloud of terms associated with the location according to the associated weights corresponding to the frequency of a term or concept.

Example 7 may optionally include the subject matter of any one or more of Examples 1-6, wherein the collected data comprises traffic volume information regarding roads proximate to the location, the traffic volume information used to provide trip planning information with the location identity.

Example 8 may optionally include the subject matter of any one or more of Examples 1-7, wherein the data analysis system correlates the traffic volume data with data associated with public transportation services for provisioning with the trip planning information.

Example 9 may optionally include the subject matter of any one or more of Examples 1-8, wherein the collected information further comprises information regarding a second location associated with the individuals after leaving the first location, the first location identity providing data for making business decisions based on the second location associated with the individuals after leaving the first location.

Example 10 may optionally include the subject matter of any one or more of Examples 1-9, wherein the collected information further comprises information regarding a status associated with an object at the first location, the first location identity providing data for determining an action with respect to the first location based on the status associated with an object at the first location.

Example 11 may optionally include the subject matter of any one or more of Examples 1-10, wherein the collected information further comprises information regarding a plurality of additional locations in an area proximate the first location, the data analysis system creating a profile for each of the plurality of additional locations and processing each of the profiles for each of the plurality of additional locations to produce location identities for each of the plurality of additional locations, the data analysis system further aggregating all of the locations' identities to produce a location identity for the area.

Example 12 may include, or may optionally be combined with the subject matter of any one or more of Examples 1-11 to include, subject matter (such as means for performing acts or machine readable medium including instructions that, when executed by the machine, cause the machine to perform acts) including collecting information regarding objects at a first location, creating a profile associated with the objects based on the collected information, processing the created profiles for the objects to produce a first location identity and providing the first location identity to a subscriber.

Example 13 may optionally include the subject matter of any one or more of Examples 1-12, wherein the objects comprise individuals at the first location.

Example 14 may optionally include the subject matter of any one or more of Examples 1-13, wherein the objects are subscribers, the information being obtained directly from the subscribers.

Example 15 may optionally include the subject matter of any one or more of Examples 1-14, wherein the objects are non-subscribers, the information being obtained from network sources the non-subscribers have published the information on.

Example 16 may optionally include the subject matter of any one or more of Examples 1-15, further comprising receiving a request for a first location identity and providing the first location identity to the individual making the request.

Example 17 may optionally include the subject matter of any one or more of Examples 1-16, wherein the objects comprise individuals, the collecting information further comprising obtaining information regarding a second location associated with the individuals after leaving the first location, the first location identity providing data for making business decisions based on the second location associated with the individuals after leaving the first location.

Example 18 may optionally include the subject matter of any one or more of Examples 1-17, wherein the objects comprise tables, the collecting of information further comprising obtaining information regarding status associated with an object at the first location, the first location identity providing data for determining an action with respect to the first location based on the status associated with an object at the first location.

Example 19 may optionally include the subject matter of any one or more of Examples 1-18, further comprising collecting information regarding a plurality of additional locations in an area proximate the first location, creating a profile for each of the plurality of additional locations and processing each of the profiles for each of the plurality of additional locations to produce location identities for each of the plurality of additional locations, and aggregating all of the locations identities to produce a location identity for the area.

Example 20 may include, or may optionally be combined with the subject matter of any one or more of Examples 1-19 to include, subject matter (such as a method or means for performing acts) including collecting information regarding objects at a first location, creating a profile associated with the objects based on the collected information, processing the created profiles for the objects to produce a first location identity and providing the first location identity to a subscriber.

Example 21 may optionally include the subject matter of any one or more of Examples 1-20, wherein the objects comprise individuals at the first location.

Example 22 may optionally include the subject matter of any one or more of Examples 1-21, wherein the objects are subscribers, the information being obtained directly from the subscribers.

Example 23 may optionally include the subject matter of any one or more of Examples 1-22, wherein the objects are non-subscribers, the information being obtained from network sources the non-subscribers have published the information on.

Example 24 may optionally include the subject matter of any one or more of Examples 1-23, further comprising receiving a request for a first location identity and providing the first location identity to the individual making the request.

Example 25 may optionally include the subject matter of any one or more of Examples 1-24, wherein the objects comprise individuals, the collecting information further comprising obtaining information regarding a second location associated with the individuals after leaving the first location, the first location identity providing data for making business decisions based on the second location associated with the individuals after leaving the first location.

Example 26 may optionally include the subject matter of any one or more of Examples 1-25, wherein the objects comprise tables, the collecting of information further comprising obtaining information regarding status associated with an object at the first location, the first location identity providing data for determining an action with respect to the first location based on the status associated with an object at the first location.

Example 27 may optionally include the subject matter of any one or more of Examples 1-26, further comprising collecting information regarding a plurality of additional locations in an area proximate the first location, creating a profile for each of the plurality of additional locations and processing each of the profiles for each of the plurality of additional locations to produce location identities for each of the plurality of additional locations, and aggregating all of the locations identities to produce a location identity for the area.

The above detailed description includes references to the accompanying drawings, which form a part of the detailed description. The drawings show, by way of illustration, specific embodiments that may be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” “third,” etc., are used merely as labels, and are not intended to impose numerical requirements on their objects

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the disclosed embodiments should be determined with reference to the appended claims, along with the full scope of equivalents to which such claims are entitled.

What is claimed is:

1. A location metadata system, comprising:
a data storage subsystem for storing collected data associated with locations and users;
a network interface, coupled to the data storage subsystem, for managing communication with devices of users to collect data associated with the locations and users; and
a data analysis system including a processor, the processor adapted for obtaining the collected data from the data storage subsystem and analyzing the collected data to create a first location identity associated with interaction of the users with a first location.

2. The location metadata system of claim 1, wherein the collected data include locations visited by the users and profiles associated with the users.

3. The location metadata system of claim 1, wherein the network interface includes a transceiver for receiving messages from and transmitting messages to the users.

4. The location metadata system of claim 1, wherein the collected data comprises profile information based on existing social media site content, context information about the first location, interactions with social media sites and physical association with the first location.

5. The location metadata system of claim 1, wherein the data analysis system normalizes the first location identity.

6. The location metadata system of claim 1, wherein the first location identity includes a collection of metadata and associated weights, the metadata represented by a tag cloud of terms associated with the first location according to the associated weights corresponding to frequency of a term or concept.

7. The location metadata system of claim 1, wherein the collected data comprises traffic volume information regarding roads proximate to the first location, the traffic volume information used to provide trip planning information with the first location identity.

8. The location metadata system of claim 7, wherein the data analysis system correlates the traffic volume information with data associated with public transportation services for provisioning with the trip planning information.

9. The location metadata system of claim 1, wherein the collected information further comprises information regarding a second location associated with the users after leaving the first location, the first location identity providing data for making business decisions based on the second location associated with the users after they have left the first location.

10. The location metadata system of claim 1, wherein the collected information further comprises information regarding a status associated with an object at the first location, the first location identity providing data for determining an action with respect to the first location based on the status associated with the object at the first location.

11. The location metadata system of claim 1, wherein the collected information further comprises information regarding a plurality of additional locations in an area proximate the first location, the data analysis system creating a profile for each of the plurality of additional locations and processing each of the profiles for each of the plurality of additional locations to produce location identities for each of the plurality of additional locations, the data analysis system further aggregating all of the location identities to produce a location identity for the area.

12. At least one machine readable medium comprising instructions that, when executed by the machine, cause the machine to perform operations for producing a location identity, the operations comprising:
collecting information regarding objects at a first location;
creating a profile associated with the objects based on the collected information;
processing the created profiles for the objects to produce a first location identity; and
providing the first location identity to a subscriber.

13. The machine readable medium of claim 12, wherein the objects comprise individuals at the first location.

14. The machine readable medium of claim 12, wherein the objects are subscribers, the information being obtained directly from the subscribers.

15. The machine readable medium of claim 12, wherein the objects are non-subscribers, the information being obtained from network sources the non-subscribers have published the information on.

16. The machine readable medium of claim 12 further comprising receiving a request for the first location identity and providing the first location identity to a user making the request.

17. The machine readable medium of claim 12, wherein the objects comprise individuals, the collecting information further comprising obtaining information regarding a second location associated with the individuals after leaving the first location, the first location identity providing data for making business decisions based on the second location associated with the individuals after they have left the first location.

18. The machine readable medium of claim 12, wherein the objects comprise tables, the collecting information further comprising obtaining information regarding a status associated with an object at the first location, the first location identity providing data for determining an action with respect to the first location based on the status associated with the object at the first location.

19. The machine readable medium of claim 12 further comprising collection information regarding a plurality of additional locations in an area proximate the first location, creating a profile for each of the plurality of additional locations and processing each of the profiles for each of the plurality of additional locations to produce location identities for each of the plurality of additional locations and aggregating all of the location identities to produce a location identity for the area.

20. A method for providing identities for locations, comprising:
collecting information regarding objects at a first location;
creating a profile associated with the objects based on the collected information;
processing the created profiles for the objects to produce a first location identity; and
providing the first location identity to a subscriber.

21. The method of claim 20, wherein the objects comprise individuals at the first location.

22. The method of claim 20, wherein the objects are subscribers, the information being obtained directly from the subscribers.

23. The method of claim 20, wherein the objects are non-subscribers, the information being obtained from network sources the non-subscribers have published the information on.

24. The method of claim 20 further comprising receiving a request for the first location identity and providing the first location identity to a user making the request.

25. The method of claim 20, wherein the objects comprise individuals, the collecting information further comprising obtaining information regarding a second location associated with the individuals after leaving the first location, the first location identity providing data for making business decisions based on the second location associated with the individuals after they have left the first location.

26. The method of claim 20, wherein the objects comprise tables, the collecting information further comprising obtaining information regarding a status associated with an object at the first location, the first location identity providing data for determining an action with respect to the first location based on the status associated with the object at the first location.

27. The method of claim 20 further comprising collection information regarding a plurality of additional locations in an area proximate the first location, creating a profile for each of the plurality of additional locations and processing each of the profiles for each of the plurality of additional locations to produce location identities for each of the plurality of additional locations and aggregating all of the location identities to produce a location identity for the area.
